(19) United States
(12) Patent Application Publication
(10) Pub. No.: US 2011/0309916 A1
(43) Pub. Date: Dec. 22, 2011

(54) Circuit Arrangement and Method for Controlling Communication Between a Control Circuit and a Transmitter/Receiver Unit via a Supply Line

(75) Inventors: Thomas MUELLER, Graz (AT); Andreas Haller, Graz (AT)

(73) Assignee: Austrimicrosystems AG, Unterpremstaetten (AT)

(21) Appl. No.: 13/112,609

(22) Filed: May 20, 2011

(30) Foreign Application Priority Data
May 20, 2010 (DE) 10 2010 022 153.8

(51) Int. Cl. G05B 11/01

(52) U.S. Cl. 340/12.37; 340/12.32

(57) ABSTRACT

A circuit arrangement is disclosed comprising a transmitter/receiver unit (1), a control circuit (2) and a supply line (3). The transmitter/receiver unit (1) comprises a supply input (4) for connecting the supply line, an energy storage unit (5) that with a first connection is coupled to the supply input (4) and that is configured to guarantee an internal energy supply during a reduction of an average supply signal (VS) at the supply input (4) over a predetermined time period, a detection unit (6) that is coupled to the supply input (4) and that is configured to detect a reduction of the average supply signal (VS) over the predetermined time period and at which an evaluation signal (AS) can be tapped, and a data transmission unit (7) that is coupled to the detection unit (6) and to the supply input (4) and that is configured to send a data signal (SD) via the supply line, depending on the evaluation signal (AS).

### RELATED APPLICATIONS

This application claims the priority of German patent application no. 10 2010 022 153.8 filed May 20, 2010, the entire content of which is hereby incorporated by reference.

### FIELD OF THE INVENTION

The present invention relates to a circuit arrangement and a method for controlling communication between a control circuit and a transmitter/receiver unit via a supply line.

### BACKGROUND OF THE INVENTION

A method for communication between a control circuit and distributed sensors that is based on a current modulation interface is known from the prior art (PSl5). It is a digital interface in which only two transmission wires are used instead of three.

The communication between the control circuit and the distributed sensors occurs via the supply line for the sensors. The data that a sensor generates are transmitted by means of current modulation. This current modulation is detected by the control circuit and processed accordingly. Furthermore, a possible synchronization of the communication between a control circuit and distributed sensors is described. For this purpose, the voltage is increased above the average supply voltage so that a voltage pulse is generated. Due to this voltage pulse on the supply line, the sensor is triggered to send its data via the supply line. Such generation of the voltage pulse can, however, require additional components that increase the production costs.

### SUMMARY OF THE INVENTION

One object of the present invention is to provide a circuit arrangement and a method for controlling communication between a control circuit and a transmitter/receiver unit via a supply line that can be simply, and thus, more cost effectively implemented.

One way in which this object is accomplished is by generating the synchronization signal by reducing the average supply voltage over a predetermined time period. Thereby, additional components (e.g., boost convertors) for generating voltages above the average supply voltage are no longer necessary. As a result, the production is simpler and more cost-effective.

In one embodiment, a transmitter/receiver unit for communicating with a control circuit via a supply line comprises a supply input for connecting to the supply line, an energy storage unit that is coupled to the supply input with a first connection, and that is designed to guarantee an internal energy supply during a reduction of an average supply signal at the supply input over a predetermined time period, a detection unit that is coupled to the supply input and that is designed to detect a reduction of the average supply signal over the predetermined time period and at which an evaluation signal can be tapped, and a data transmission unit that is coupled to the detection unit and to the supply input, and that is designed to send a data signal via the supply line depending on the evaluation signal.

In one embodiment, the data transmission unit comprises a sensor unit for measuring physical variables that is coupled with an input to the detection unit, that is coupled to an output to the supply input, and that is designed to send the data signal via the supply line.

The detection unit is designed for the purpose of detecting a reduction of an average supply voltage VS over the predetermined time period.

In one embodiment, the data transmission unit is designed to generate the data signal by current modulation of a supply current on the supply line.

In a further development, the detection unit comprises at least one comparator or differential amplifier that is coupled with a first input to the supply input, that is coupled with a second input to a reference signal, and that is designed to provide at an output the evaluation signal from a comparison of the reference signal with the signal at the first input.

In a further embodiment of the transmitter/receiver unit, the energy storage unit comprises at least one diode that is coupled with a first connection to the supply input, and that is designed for providing an internal supply signal at a second connection, and an energy store that is coupled with a first connection to the second connection of the diode.

In a further development, the energy store comprises a capacitor. The capacitance of this capacitor is dimensioned so that the internal energy supply of the transmitter/receiver unit is guaranteed during a reduction of the average supply signal at the supply input during the predetermined time period.

In an alternative embodiment, the transmitter/receiver unit has a detection unit and a data transmission unit. The energy storage unit can be omitted if the predetermined time period of a synchronization signal is selected to be short enough that the internal energy storage of the transmitter/receiver unit is guaranteed even without the energy storage unit, and therefore the transmitter/receiver unit is not reset into an undefined initial condition.

In an alternative embodiment of the transmitter/receiver unit, the synchronization signal can be a current pulse that is represented by a momentary reduction of the average supply current. The detection unit is designed here to detect a changed current over the predetermined time period, and the data transmission unit is designed to generate the data signal by a voltage modulation of the average supply voltage.

Another aspect relates to a control circuit for controlling communication to a transmitter/receiver unit via a supply line. This comprises a supply output for the connection of the supply line, and a supply unit that comprises a control input for the connection of a control signal and that is designed to provide an average supply signal at the supply output, wherein the control circuit is designed for generating a synchronization signal to reduce the average supply signal over a predetermined time period, depending on the control signal.

In a further development, the average supply signal is an average supply voltage.

In one embodiment, a switching unit is disposed between the supply output and the supply unit that is designed for generating a synchronization signal to reduce the average supply signal over the predetermined time period, depending on the control signal. The supply unit can be deactivated via the control signal.

In an alternative embodiment, the supply unit comprises at least one first voltage regulator, a second voltage regulator that differs from the first voltage regulator in the characteristic of the generated voltage potential, and a switch that for generating a synchronization signal with a first connection, depending on the control signal at a third connection, is coupled either to the first voltage regulator or to the second voltage regulator, and that is coupled via a second connection to the supply output. The supply unit can alternatively have only one voltage regulator that provides two different voltage values depending on the control signal.

In an alternative embodiment of the control circuit, the supply unit comprises at least one first voltage regulator reference, a second voltage regulator reference that differs from the first voltage regulator reference in the characteristic of the generated voltage potential, a switch that for generating a synchronization signal with a first connection, depending on the control signal at a third connection, is coupled either to the first voltage regulator reference or to the second voltage regulator reference, and a voltage regulator that is coupled with a first connection to a second connection of the switch and that is coupled via a second connection to the supply output. The supply unit can alternatively have a voltage regulator and only one voltage regulator reference, which provides two different voltage reference values depending on the control signal.

In a further development of the control circuit, an evaluation unit for evaluating a current modulation on the supply line is disposed between the supply unit and the circuit unit.

The evaluation unit can comprise at least one measurement resistance that with a first connection is coupled to the supply unit and that with the second connection is coupled to the switching unit, and a differential amplifier that with a first input is coupled to the supply unit and with the second input is coupled to the switching unit.

In an alternative embodiment of the control circuit, the average supply signal is a supply current. The synchronization signal can be implemented by a current pulse that triggers a data transmission of the transmitter/receiver unit, which is implemented as a voltage modulation. The evaluation unit of the control circuit is designed accordingly to evaluate a voltage modulation.

A further aspect of the invention relates to an arrangement for a bidirectional communication between a control circuit and a transmitter/receiver unit via a supply line. This arrangement comprises a control circuit, a transmitter/receiver unit and the supply line, which couples the control circuit to the transmitter/receiver unit.

A further aspect of the invention relates to a method for controlling a communication between a control circuit and a transmitter/receiver unit via a supply line. This comprises feeding an average supply signal, reducing the average supply signal over a predetermined time period for synchronization of the communication between the control circuit and the transmitter/receiver unit depending on a control signal, detecting the reduced averaged supply signal, and transmitting a data signal in reply to the detected, reduced average supply signal.

In a further development of the method, the average supply signal is an average supply voltage. The reduction of the averaged supply voltage over the predetermined time period comprises at least one of the following steps:

reducing the average supply voltage to a value between a reference potential and the average supply voltage,

reducing the average supply voltage to the reference potential,

reducing the average supply voltage to a value below the reference potential.

In one embodiment, the transmission of the data signal comprises modulating a supply current which is derived from the average supply signal.

In an alternative embodiment of the method, the average supply signal is a supply current. Therefore, the synchronization signal is represented by a reduction of the supply current over the predetermined time period. In response to the reduced supply current, the transmitter/receiver unit sends a data signal that is designed as a voltage modulation. The voltage modulation is subsequently evaluated by the evaluation unit of the control circuit.

The transceiver/receiver unit can be used in any kind of vehicles, particularly motor vehicles like cars, trucks and the like. To this extent, the communication signals may be transmitted on the supply line within the vehicle coupling all devices with an internal energy storage.

### BRIEF DESCRIPTION OF THE DRAWINGS

In the drawings, components and circuit elements that are functionally equivalent or have the same effect bear the same reference symbols. Insofar as circuit parts or components correspond in their function, their description is not repeated in each of the following figures.

FIG. 1 shows a first embodiment of an arrangement for bidirectional communication between a control circuit and a transmitter/receiver unit via a supply line,

FIG. 2 illustrate a second embodiment of the invention,

FIG. 3 shows a third embodiment of the invention,

FIG. 4 shows a flow chart for illustrating the process flows of the method in the transmitter/receiver unit.

### DETAILED DESCRIPTION OF THE DRAWINGS

The individual embodiment examples are represented schematically in the figures, wherein individual elements necessary for the function are omitted for clarity. It is understood by the person skilled in the art that individual aspects from the embodiments can be combined together or supplemented. In particular, the control circuits and transmitter/receiver units of the individual embodiments can be combined together.

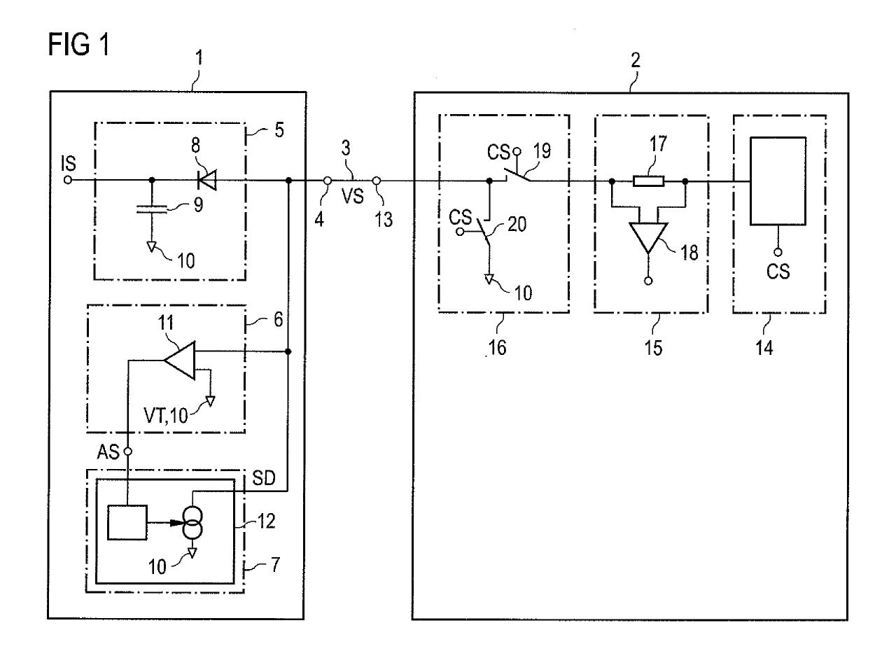

FIG. 1 shows a circuit arrangement according to an embodiment of the invention. The circuit is arranged in a vehicle, for example in a car and coupled to the internal power supply line of the vehicle supplying all devices within the vehicle with the necessary power. The circuit arrangement comprises a transmitter/receiver unit 1, a control circuit 2 and a supply line 3.

The transmitter/receiver unit 1 comprises a supply input 4 for connecting the supply line 3, an energy storage unit 5, a detection unit 6, and a data transmission unit 7. The energy storage unit 5 comprises a diode 8 and a capacitor 9. The first connection of the diode 8 is coupled to the supply input 4. An internal supply signal IS can be tapped at the second connection of the diode 8. The first connection of the capacitor 9 is coupled to the second connection of the diode 8, and the second connection is connected to a reference potential connection 10. The detection unit 6 comprises a comparator 11, the first input of which is connected to the supply input 4 and the second input of which is connected to the reference potential connection 10. An evaluation signal AS can be tapped at the output of the comparator. The data transmission unit 7 comprises a sensor 12, that is coupled with an input to the output of the comparator 11, that is coupled with an output to the supply input 4.

The communication of the transmitter/receiver unit 1 with the control circuit 2 occurs over the supply line 3, which supplies an average supply voltage VS to the transmitter/receiver unit 1 at supply input 4. Particularly in the case of connecting several transmitter/receiver units to the supply line 3, however, it is important to synchronize the communication for the purpose of creating a common time base for the components involved in the communication. For synchronizing, the average supply voltage VS is momentarily reduced to a reference potential (e.g., 0 volts) and then increased again to the original value of the average supply voltage.

So that the momentary reduction of the average supply voltage VS does not lead to a destabilization of the internal supply signal IS, the energy storage unit 5 is present, which comprises the diode 8 and the capacitor 9. The capacitance of the capacitor 9 is dimensioned so that the internal supply signal IS remains stable during the reduction of the supply voltage VS to the reference potential. When the transmitter/receiver unit 1 is supplied with the average supply voltage VS, then the capacitor 9 is charged via the diode 8. In the case that the supply voltage VS is reduced, the diode 8 prevents the charge of the capacitor 9 from discharging to the supply input 4.

The voltage pulse implemented by the reduction of the supply voltage is detected by the detection unit 6. For this purpose, the comparator 11 compares the reduced average supply voltage VS at the first input to the reference potential at the second input, and provides the evaluation signal AS at the output. The sensor 12 of the data transmission unit 7 evaluates the evaluation signal AS and checks whether the average supply voltage VS was reduced over the predetermined time period.

In this example embodiment, the transmitter/receiver unit that is to transmit data as a consequence of the synchronization pulse is determined by the duration of the time period in which the average supply voltage VS is reduced to the reference potential. This is particularly relevant in the case of connecting several transmitter/receiver units 1 to the supply line 3, because here the communication between the different transmitter/receiver units 1 and the control circuit 2 must be synchronized. The sensor 12 of the selected transmitter/receiver unit 1 then transmits a data signal SD via the supply line 3, in order to transmit the previously collected physical information to the control circuit 2.

Alternatively, the sensor 12 can begin with the collection of information only after the selection by the synchronization pulse, and can begin the transmission of the data signal SD after a predetermined time delay. If a different time delay is set for each transmitter/receiver unit 1 connected to the supply line 3, then each transmitter/receiver unit 1 can be assigned an individual time slot for the transmission of data. The duration of the synchronization pulse can be selected to always be same in this example. The transmitter/receiver unit 1 can also comprise several different sensors 12 that after selection of the associated transmitter/receiver 1 by the synchronization pulse transmit their data to the control unit 2 after a predetermined time delay. In this case, several time slots are occupied by a transmitter/receiver unit 1. Alternatively, only one time slot can also be occupied, that then is divided only internally in the transmitter/receiver unit 1 between the sensors 12.

The transmission of the data signal SD from the transmitter/receiver unit 1 to the control circuit 2 comprises a modulation of a supply current that is derived from the average supply voltage. The current modulation can be implemented using a voltage-controlled current source that has at least one operational amplifier and a field effect transistor. The modulation of the input voltage of the current source leads to a modulated supply current at the output of the current source.

The control circuit 2 from FIG. 1 for controlling a communication with the transmitter/receiver unit 1 via the supply line 3 comprises a supply output 13 for connecting the supply line 3, a supply unit 14, an evaluation unit 15 that is disposed between the supply unit 14 and the supply output 13, and a switching unit 16 that is disposed between the supply output 13 and the evaluation unit 15.

The supply unit 14 is designed to provide the average supply voltage VS at the supply output 13. The unit comprises a control input to which the control signal CS can be applied for deactivating the supply unit 14, and an output to which the evaluation unit 15 is coupled.

The evaluation unit 15, for evaluating a current modulation on the supply line 3, comprises a measurement resistance 17 that with a first connection is coupled to the supply unit 14 and that with a second connection is coupled to the switching unit 16, and a differential amplifier 18 that with a first input is coupled to the supply unit 14 and with a second input is coupled to the switching unit 16.

The switch unit 16 is designed to generate a synchronization signal depending on a control signal CS. The unit comprises a first switch 19 that with a first connection is coupled to the evaluation unit 15 and that with a second connection is coupled to the supply output 13, and that can be switched depending on the control signal CS at a third connection, and a second switch 20 that with a first connection is coupled to the supply output 13 and that with a second connection is connected to the reference potential 10, and that can be switched depending on the control signal CS at a third connection.

The control circuit 2 communicates with the transmitter/receiver unit 1 via the supply line 3. In the case of only one connected transmitter/receiver unit 1, this unit can continuously transmit data to the control circuit 2. If however, several transmitter/receiver units are connected to the supply line 3, a synchronization of this communication is required because in this case all transmitter/receiver units can not transmit data at the same time. For controlling the communication between the control circuit 2 and the transmitter/receiver unit 1, a synchronization pulse is sent from the control circuit 2 to a specific transmitter/receiver unit, for example. In response to the synchronization pulse, this unit sends data to the control circuit 2.

The synchronization pulse is generated in that the average supply voltage VS, which is provided in the first state of the control signal CS at the supply output 13, with the switching of the control signal CS into a second state, is reduced over a predetermined time period to the reference potential (e.g., 0 volts). Next, the voltage at the supply output 13 is again increased to the average supply voltage VS. In this example embodiment, the control signal CS directly controls the duration of the reduction of the average supply voltage VS, i.e., as long as a control signal CS is reduced, the average supply voltage VS is also reduced. In an alternative embodiment, the duration of the reduction of the average supply voltage VS can be stored in the control circuit CS. In this case, only a short pulse from CS is sufficient in order to reduce the average supply voltage VS over the predetermined time period. The duration of the reduction serves for selecting a transmitter/receiver unit 1 that is thereby prompted to transmit its data via the supply line 3 to the control circuit 2.

In detail, in the second state of the control signal CS, the supply unit 14 is activated, the first switch 19 of the switching unit 16 is opened, in order to electrically disconnect the supply unit 14 from the supply output 13, and the second switch 20 of the switch unit 16 is closed, in order to connect the supply line 3 to the reference potential 10.

When the control signal CS switches into the first state, the supply unit 14 is the activated and the first switch 19 of the switching unit 16 is closed, in order to couple the supply unit 14 to the supply output 13, and the second switch 20 of the switch unit 16 is opened, in order to electrically disconnect the supply line 3 from the reference potential 10. Thus, the average supply voltage VS is again present at the supply output 13.

If the data signal SD is sent from the transmitter/receiver unit 1 in response to the generated synchronization signal, a changing voltage across the measurement resistor 17 of the evaluation unit 15 is generated by the current modulation that is evaluated by the differential amplifier 18. The evaluated data can be supplied to further processing.

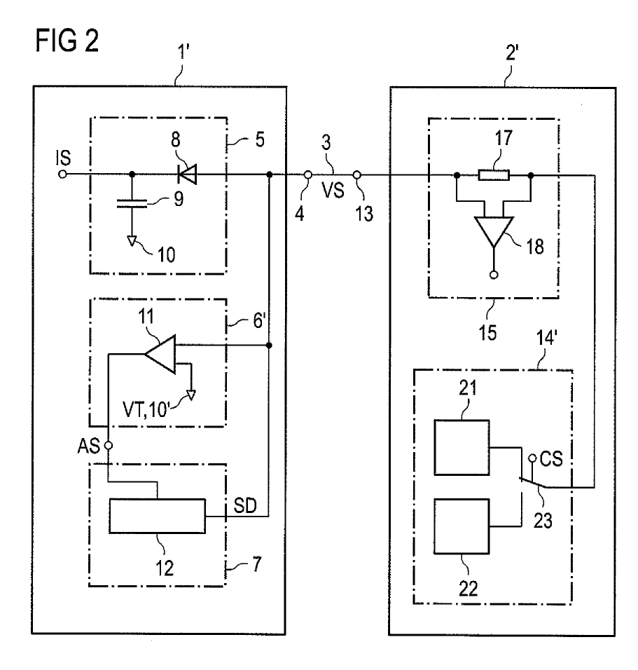

FIG. 2 shows a further embodiment of the circuit arrangement according to the invention. A circuit arrangement comprises a transmitter/receiver unit 1′, a control circuit 2′, and the supply line 3. For the same elements, compared with FIG. 1, the same reference symbols are used. In so far as these elements were already described in the embodiment of FIG. 1, no further explanation is provided here.

The transmitter/receiver unit 1′ corresponds in design and function to the transmitter/receiver unit 1 from the example embodiment for FIG. 1, with the difference that the second input of the comparator 11 of a detection unit 6′ is coupled to a reference potential connection 10′. A reference potential that corresponds to half the value of the average supply voltage VS, is connected to this reference potential connection 10′. Alternatively, other values between the average supply voltage VS and the reference potential (0 volts) can naturally also be set.

As described in the explanations to FIG. 1, in the case of a connection of several transmitter/receiver units 1′ to a supply line 3, a synchronization between the participating components is required for an orderly communication between a transmitter/receiver unit 1′ and a control circuit 2′. For this purpose, in this example embodiment the average supply voltage VS is reduced over the predetermined time period to half the value, and is subsequently again increased to the previous value of the average supply voltage VS. By this synchronization pulse, the transmitter/receiver unit 1′ is prompted to transmit its data over the supply line 3 to the control circuit 2′. In this example embodiment, the duration of the reduction of the average supply voltage VS is always equally long, even in the case of connecting several transmitter/receiver units to the supply line. The synchronization of the data transmission from the different transmitter/receiver units 1′ to the control circuit 2′ occurs over a common time base that is provided via the synchronization pulse, and a fixed specified time offset that is individually given to each transmitter/receiver unit 1′. This time offset determines the time, calculated from a synchronization pulse, after which the transmitter/receiver unit 1′ begins to transmit data to the control circuit 2′.

Alternatively, with the use of a window comparator in the detection unit 6′ the voltage potential to which the average supply voltage VS is reduced can be used as a criteria for the selection of the transmitter/receiver unit 1′. In this alternative embodiment that is not displayed, different transmitter/receiver units 1′ can be selected using a synchronization pulse in which the supply voltage VS is reduced to different voltage values.

If the transmitter/receiver unit 1′, as in the named alternative or as shown in the example embodiment for FIG. 1, is selected using an individual synchronization pulse then it is not mandatory to set a time delay for the transmission of the data signal SD, because in each case only one transmitter/receiver unit 1′ is selected by the synchronization pulse.

The reduction of the average supply voltage VS to half the voltage value is detected by the detection unit 6′ of the transmitter/receiver unit 1′. In detail, the comparator 11 of the detection unit 6′ compares the voltage at its first input with half of the average voltage value VS at its second input, and provides an evaluation signal AS at its output. This is supplied to the data transmission unit 7. The data transmission unit 7 evaluates the time period in which the average supply voltage was initially reduced to half its value and again increased to the original value. If this time period corresponds to at least one predetermined time period, then a synchronization pulse is present. As a consequence of this, the data transmission unit 6′ determines the current data of the sensor 12 and transmits this after a predetermined time delay in the form of current modulation via the supply line 3 to the control circuit 2′.

The control circuit 2′ from FIG. 2 comprises a supply unit 14′ that is designed to provide, depending on a control signal CS at the control input, the average supply voltage VS or a reduced average supply voltage VS at a supply output 13, and an evaluation unit 15 for evaluating a current modulation on the supply line 3 that is disposed between the supply unit 14′ and the supply output 13.

The supply unit 14′ comprises a first voltage regulator 21 and a second voltage regulator 22, which can be distinguished in the characteristic of the generated voltage potential, and a switch 23 that with a first connection, depending on the control signal CS at a third connection, is coupled either to the first voltage regulator 21 or to the second voltage regulator 22, and which is coupled to the evaluation unit 15 with a second connection.

Alternatively, the supply unit 14′ can also provide only one voltage regulator that is designed to provide, depending on the control signal CS, at least two different voltage potentials.

In the evaluation unit 15, a measurement resistor 17 is provided that with a first connection is coupled to the second connection of the switch 23, and with a second connection is coupled to the supply output 13. In addition, the evaluation unit 15 has a differential amplifier 18 that with a first input is coupled to the second connection of the switch 23, and that with a second input is coupled to the supply output 13.

The control circuit 2′ is designed to generate the synchronization pulse for synchronizing the communication. For this purpose, the average supply voltage VS, that in a first state of the control signal CS is provided to the supply output 13, is reduced in a second state of the control signal CS to half the average supply voltage VS over the predetermined time period. Afterwards, the control signal CS switches again into the first state and the average supply voltage VS is again provided at the supply output 13. The duration of the reduction of the voltage is always the same in this example embodiment, even in the case connecting multiple transmitter/receiver units 1′ to the supply line 3. The synchronization of the communication is guaranteed by means of a different, fixed set time delay in the transmitter/receiver units 1′.

In detail, in the first state of the control signal CS, the first connection of the switch 23 of the supply unit 14′ is coupled to the first voltage regulator 21. Thereby, the average supply voltage VS is made available at the supply output 13 of the control circuit 2′. In the second state of the control signal CS, the first connection of the switch 23 is coupled to a second voltage regulator 22. Thereby, half the average supply voltage VS is made available at the supply output 13 of the control circuit 2′. When the control signal CS switches for a predetermined time period from the first state into the second state, and subsequently back into the first state, the synchronization signal can hereby be formed at the supply output 13.

Alternatively, the average supply voltage can be reduced to other values between the average supply voltage VS and the reference potential (e.g., 0 volts).

In a further alternative, the transmitter/receiver unit 1′ is selected by the specific voltage potential to which the average supply voltage VS is reduced during the second state of the control signal CS. The individual transmitter/receiver units 1′ are selected here by the use of different voltage potentials. For generating these different voltage potentials, the supply unit 14′ can comprise either several voltage regulators having different voltage potentials, or it can comprise only one voltage regulator that is designed to provide several different voltage potentials.

When the data signal SD is sent from the transmitter/receiver unit 1′ in response to the generated synchronization signal, a changing voltage across the measurement resistance 17 of the evaluation unit 15 is generated by the current modulation and is evaluated by the differential amplifier 18. The evaluated data can be supplied to further processing.

In an alternative embodiment, not shown, there is no direct coupling between the duration of the state change of the control signal CS and the duration of the synchronization pulses. A short state change of the control signal CS is therefore only a starting point for the reduction of the average supply voltage VS. The time duration of the synchronization signal can be stored in a supply unit 14′.

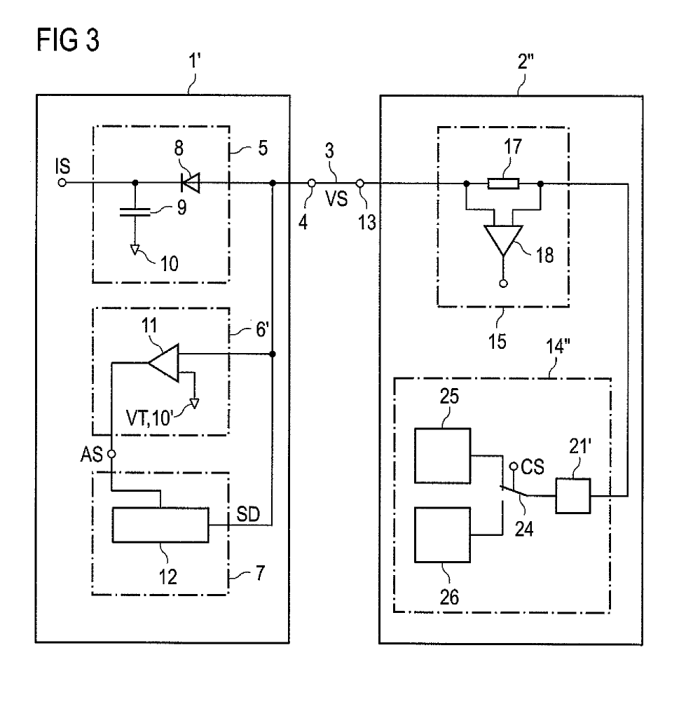

FIG. 3 shows a further embodiment of the circuit arrangement according to the invention. The circuit arrangement comprises a transmitter/receiver unit 1′, a control circuit 2″, and the supply line 3. For the same elements, compared with FIG. 2, the same reference symbols are used. In so far as these elements were already described in the embodiment for FIG. 2 with the same function, no further explanation is provided here. The transmitter/receiver unit 1′ corresponds essentially to the preceding embodiment.

The control circuit 2″ comprises a supply unit 14″ and the evaluation unit 15 for evaluating a current modulation on the supply line 3, that is disposed between the supply unit 14″ and the supply output 13.

The supply unit 14″ is designed to provide, depending on the control signal CS at a control input, the average supply voltage VS, or an average supply voltage VS reduced to half, at the supply output 13. The unit comprises a first voltage regulator reference 25 and a second voltage regulator reference 26, that differ in the feature of the generated voltage potential. Furthermore, the supply unit 14″ comprises a switch 24 that, depending on the control signal CS at a third connection, is coupled with a first connection either to the first voltage regulator reference 25 or to the second voltage regular reference 26. Furthermore, the supply unit 14″ comprises a voltage regulator 21′ that with a first connection is coupled to a second connection of the switch 24, and that via a second connection is coupled to the evaluation unit 15.

Alternatively, the supply unit 14″ can also be provided with only one voltage regulator that is designed, depending on the control signal CS, to provide at least two different voltage potentials.

The design and function of the evaluation unit 15 are similar to the embodiment of FIG. 2.

For synchronizing the communication between the control circuit 2″ and the transmitter/receiver unit 1′, the control circuit 2″ transmits a synchronization pulse via the supply line 3 to the transmitter/receiver unit 1′. The transmitter/receiver unit 1′ is thereby triggered to transmit, after a fixed time delay set in the transmitter/receiver unit 1′, the data signal SD via the supply line 3 to the control circuit 2″. The synchronization pulse is represented by a reduction of the average supply voltage VS to half the voltage value, and a subsequent increase of the voltage to the original average supply voltage VS. The duration of the reduction is always the same in this example embodiment. The synchronization of the data signal SD of several transmitter/receiver units occurs using a individually fixed time delay, relative to the receipt of a synchronization pulse, for each transmitter/receiver unit 1′. Using the individual time delay of each transmitter/receiver unit 1′ guarantees that each transmitter/receiver unit 1′ is assigned an individual time slot for the transmission of data, and thus, the transmitted data signals SD do not interfere with each other.

The generation of the synchronization pulse is described in the following. The control circuit 2″, in a first state of the control signal CS, provides the average supply voltage VS at the supply output 13. In a second state of the control signal CS, the voltage at the output 13 is reduced to half the average supply voltage VS. After the expiration of the predetermined time period, the voltage is then again increased to the average supply voltage VS. In detail, in the first state of the control signal CS, the first connection of the switch 24 of the supply unit 14″ is coupled to the first voltage regulator reference 25. Thereby, the average supply voltage VS is made available at the supply output 13 of the control circuit 2″. In the second state of the control signal CS, the first connection of the switch 24 is coupled to a second voltage regulator reference 22. As a result, half the average supply voltage VS is made available at the supply output 13 of the control circuit 2″.

Alternatively, the synchronization of several transmitter/receiver units 1′ can also occur in that the average supply voltage VS is reduced to different voltage potentials. For generating these different voltage potentials, the supply unit 14″ can comprise several voltage regulator references that each provide a voltage potentials. The unit can however also have only one voltage regulator reference that is capable of generating several voltage potentials depending on the control signal CS.

When the data signal SD is sent from the transmitter/receiver unit 1′ via the supply line 3 in response to the generated synchronization signal, a changing voltage across the measurement resistance 17 of the evaluation unit 15 is generated by the current modulation that is evaluated by the differential amplifier 18. The evaluated data can be supplied to further processing.

In an alternative embodiment, not shown, the transmitter/receiver unit 1, 1′ comprises only one detection unit 6, 6′ and a data transmission unit 7. An energy storage unit 5 is not necessary if the average supply voltage VS for generating this synchronization pulse is reduced for such a brief time such that the internal energy supply of the transmitter/receiver unit 1, 1′ is guaranteed without the energy storage unit 5, and the transmitter/receiver unit 1, 1′ does not therefore enter into a defined starting state in which the information currently present in the sensor 12 is lost.

In a further alternative embodiment, not shown, the average supply signal VS can be implemented as a supply current. The synchronization signal is then represented by a momentary reduction and subsequent increase to the original value of the supply current. The data signal SD that is sent in response to this synchronization signal from the transmitter/receiver unit via the supply line 3, can be implemented as a modulation of the supply voltage derived from the supply current.

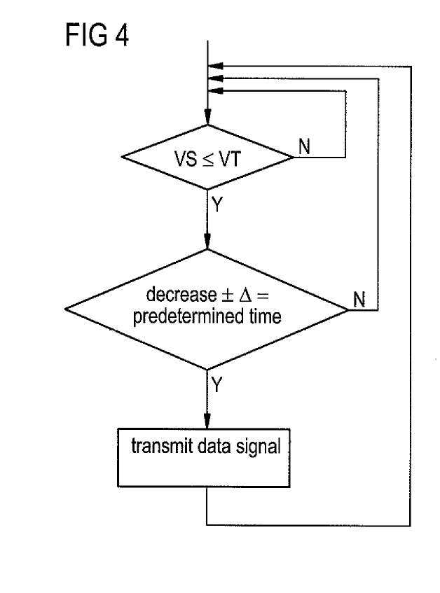

FIG. 4 shows a flow diagram for illustrating the process flows of the method in a transmitter/receiver unit. The following description refers to a transmitter/receiver unit 1 and a control circuit 2, but is not limited to this specific embodiment of the transmitter/receiver unit or the control circuit.

In the case of coupling the control circuit 2 to several transmitter receiver units 1 via a supply line 3, it is necessary to synchronize the communication between the participating components. This synchronization ensures that different data signals SD that are sent from the different transmitter/receiver units 1 to not interfere with each other during the transmission via the supply line 3.

In detail, the method comprises supplying an average supply voltage VS via the supply line 3. For synchronizing the control circuit 2 and the transmitter/receiver unit 1, the average supply voltage VS is initially reduced by the control circuit to a reference potential VT (e.g., 0 volts), and after a predetermined time period has elapsed, increased again to the original value. For the correct identification of this synchronization pulse on the side of the transmitter/receiver unit 1, the potential of the supply voltage is compared to the reference potential VT (e.g., 0 volts or also slightly above). When the supply voltage was reduced to a potential that corresponds to the reference potential VT or lies below the reference potential VT, then a first criteria is satisfied for identifying a synchronization pulse. The duration of the reduction of the average supply voltage VS represents a second criteria. If the duration of the reduction lies within a defined range of the predetermined time period, then the second criteria for identification is also satisfied Consequently, the transmitter receiver unit 1 is selected and thus prompted to transmit the collected physical information to the control circuit 2. For this purpose, the data signal SD is transmitted via the supply line 3 to the control circuit 2.

In the case of connecting several transmitter/receiver units 1 to the supply line 3, each transmitter receiver unit 1 is set with an individual predetermined time period. Different transmitter/receiver units 1 are selected by varying the duration of a synchronization pulse.

In an alternative embodiment of the method, the duration of the synchronization pulse can be selected to be the same for all transmitter/receiver units 1. Here, a uniform time base is created using a synchronization pulse. By using an individual, fixed time delay for each transmitter/receiver unit 1, the transmitter/receiver units 1 transmit their data in an individual time slot via the supply line 3 to the control circuit 2. Interference of the different data signals SD is therefore excluded.

The scope of protection of the invention is not limited to the examples given hereinabove. The invention is embodied in each novel characteristic and each combination of characteristics, which includes every combination of any features which are stated in the claims, even if this feature or combination of features is not explicitly stated in the examples.

We claim:

1. A transmitter/receiver unit for communicating with a control circuit via a supply line, comprising:
a supply input for connecting the supply line;
an energy storage unit that with a first connection is coupled to the supply input, and that is configured to provide an internal energy supply during a reduction of the average supply signal at the supply input over a predetermined time period;
a detection unit that is coupled to the supply input, and that is configured to detect a reduction of the average supply signal over the predetermined time period, and at which an evaluation signal can be tapped; and
a data transmission unit that is coupled to the detection unit and to the supply input, and that is configured to send the data signal via the supply line, depending on the evaluation signal.

2. The transmitter/receiver unit according to claim 1, wherein the data transmission unit comprises a sensor unit for measuring physical variables that is coupled with one input to the detection unit, that is coupled with one output to the supply input, and that is designed to send the data signal via the supply line.

3. The transmitter/receiver unit according to claim 1, wherein the detection unit is configured to detect a reduction of an average supply voltage over the predetermined time period.

4. The transmitter/receiver unit according to claim 1, wherein the data transmission unit is configured to generate the data signal by a current modulation of the supply current.

5. The transmitter/receiver unit according to claim 1, wherein the detection unit comprises at least one comparator that with a first input is coupled to the supply input, that with a second input is coupled to the reference signal, and that is configured to provide the evaluation signal at an output.

6. The transmitter/receiver unit according to claim 1, wherein the energy storage unit comprises:
a diode that with a first connection is coupled to the supply input, and that is configured to provide an internal supply signal at a second connection, and
an energy storage that with a first connection is coupled to the second connection of the diode.

7. A control circuit for controlling a communicating with a transmitter/receiver unit via a supply line, comprising:
a supply output for connecting the supply line; and
a supply unit that comprises a control input for the connection of a control signal and that is configured to provide an average supply signal at a supply output,
wherein the control circuit is configured for generating a synchronization signal, depending on the control signal for reducing the average supply signal over a predetermined time period.

8. The control circuit according to claim 7, wherein the average supply signal is an average supply voltage.

9. The control circuit according to claim 7, wherein a switching unit is disposed between the supply output and the supply unit that is configured for generating a synchronization signal, depending on the control signal, to reduce the average supply signal over the predetermined time period, and the supply unit can be deactivated via the control signal.

10. The control circuit according to claim 9, wherein the switching unit comprises:
a first switch that with a first connection is coupled to the supply unit, that with a second connection is coupled to the supply output, and that can be switched depending on the control signal to a third connection, and
a second switch that with a first connection is coupled to the supply output, that with a second connection is coupled to the reference potential connection, and that can be switched depending on the control signal to a third connection.

11. The control circuit according to claim 8, wherein the supply unit comprises:
a first voltage regulator;
a second voltage regulator that is distinguished from the first voltage regulator in the characteristic of the generated voltage potential; and
a switch that for generating a synchronization signal with a first connection, depending on the control signal at a third connection, is coupled either to the first voltage regulator or to the second voltage regulator, and that with a second connection is coupled to the supply output.

12. The control circuit according to claim 8, wherein the supply unit comprises:
a first voltage regulator reference;
a second voltage regulator reference that is distinguished from the first voltage regulator reference in the characteristic of the generated voltage potential;
a switch that for generating a synchronization pulse with a first connection, depending on the control signal at a third connection, is coupled to either the first voltage regulator reference or to the second voltage regulator reference; and
a voltage regulator that with a first connection is coupled to a second connection of the switch, and that via a second connection is coupled to the evaluation unit.

13. The control circuit according to claim 7, wherein an evaluation unit, for evaluating a current modulation of the supply line, is disposed between the supply unit and the switching unit.

14. The control circuit according to claim 13, wherein the evaluation unit comprises:
a measurement resistor that with a first connection is coupled to the supply unit, and that with a second connection is coupled to the switching unit; and
a differential amplifier that with a first input is coupled to the supply unit, and that with a second input is coupled to the switching unit.

15. An arrangement for a bidirectional communication between a control circuit and a transmitter/receiver unit via a supply line, comprising:
a control circuit according to claim 7;
a transmitter/receiver unit comprising:
a. a supply input for connecting the supply line,
b. an energy storage unit that with a first connection is coupled to the supply input, and that is configured to provide an internal energy supply during a reduction of the average supply signal at the supply input over a predetermined time period,
c. a detection unit that is coupled to the supply input, and that is configured to detect a reduction of the average supply signal over the predetermined time period, and at which an evaluation signal can be tapped,
d. a data transmission unit that is coupled to the detection unit and to the supply input, and that is configured to send the data signal via the supply line, depending on the evaluation signal, and
the supply line that couples the control circuit to the transmitter/receiver unit.

16. A method for controlling communication between a control circuit and a transmitter/receiver unit via a supply line, comprising:
supplying an average supply signal;
reducing the average supply signal over a predetermined time period for synchronizing the communication between the control circuit and the transmitter/receiver unit, depending on a control signal;
detecting the reduced average supply signal; and
transmitting a data signal in reply to the detected reduced average supply signal.

17. The method according to claim 16,
wherein the average supply signal is provided by a supply unit of the control circuit at a supply output,
wherein the average supply signal is reduced by a switching unit of the control circuit over the predetermined time period,
wherein the reduced average supply signal is detected in a detection unit of the transmitter/receiver unit, and
wherein the data signal is generated in a data transmission unit of the transmitter/receiver unit.

18. The method according to claim 16, wherein the average supply signal is an average supply voltage, and the reduction of the average supply voltage over the predetermined time period comprises the steps of:
reducing the averaged supply voltage to a value between a reference potential and the average supply voltage;
reducing the average supply voltage to the reference potential; and
reducing the average supply voltage to a value below the reference potential.

19. The method according to claim 16, wherein the transmission of the data signal comprises modulating a supply current which is derived from the average supply signal.
